(19) United States
(12) Patent Application Publication
(10) Pub. No.: US 2025/0021864 A1
(43) Pub. Date: Jan. 16, 2025

(54) AUTOMATIC DETERMINATION OF DATA SAMPLES IN NEED OF HUMAN ANNOTATION FOR A MACHINE LEARNING MODEL IMPROVEMENT

(71) Applicants: Daniel Kaluza, Warsaw (PL); Antoni Jamiolkowski, Warsaw (PL); Andrzej Janusz, Warsaw (PL); Igor Marczak, Warsaw (PL); Maciej Matraszek, Warsaw (PL); Andrzej Skowron, Warsaw (PL); Dominik Slezak, Warsaw (PL)

(72) Inventors: Daniel Kaluza, Warsaw (PL); Antoni Jamiolkowski, Warsaw (PL); Andrzej Janusz, Warsaw (PL); Igor Marczak, Warsaw (PL); Maciej Matraszek, Warsaw (PL); Andrzej Skowron, Warsaw (PL); Dominik Slezak, Warsaw (PL)

(21) Appl. No.: 18/220,215

(22) Filed: Jul. 10, 2023

(51) Int. Cl. G06N 20/00; G06Q 10/0631

(52) U.S. Cl. CPC G06N 20/00; G06Q 10/06312

(57) ABSTRACT

In one embodiment, a method includes determining which objects from a substantial dataset are expected to lead to the largest increase in model quality by applying a samples-selection algorithm using computational capability comprising a processor and/or a memory (e.g., of a processing system and/or a graphics processing unit). The aspect quantifies an informativeness score of data elements in the substantial dataset to determine how likely and/or by what degree data elements will lead to model improvement. The method then automatically determines which data elements of the substantial dataset are in need of human annotation based on a prioritization order derived from the informativeness score and chooses a selected data based on the automatically determining which elements of the substantial dataset are in need of human annotation based on the prioritization order derived from the informativeness score. The method then matches the selected data to an expert.

### FIELD OF TECHNOLOGY

This disclosure relates generally to the field of training machine learning models, and more specifically to a method and system of automatic determination of which data samples are in need of human annotation to improve a machine learning model.

### BACKGROUND

A machine learning model may be a mathematical representation and/or an algorithm that is trained on data to make predictions (or decisions) without being explicitly programmed. The machine learning model may be designed to learn patterns and relationships from input data, which could be numerical values, text, images, and/or any other type of structured or unstructured data. During the training process, the machine learning model may be presented with a set of labeled examples, known as the training data, and may adjust its internal parameters to find patterns and correlations in the data.

As part of this training process, data may be labeled with certain “annotations” which may provide the necessary ground truth or reference information to enable a model to learn patterns and make predictions on new, unseen data. Annotations may come in many different forms, including image annotations, text annotations, audio annotations, and video annotations. Annotations may be created by human annotators who review the data and apply the relevant labels according to predefined guidelines and/or their knowledge. This process can be time-consuming and labor-intensive, especially for large datasets. In some cases, crowdsourcing platforms or annotation tools are used to distribute the annotation workload among multiple annotators.

The quality and accuracy of annotations are crucial for training effective machine learning models. Annotators often undergo training and quality control measures to ensure consistency and reduce errors. Additionally, iterative feedback loops between annotators and model training help refine the annotation guidelines and improve the overall performance of the machine learning system.

Supervised classification algorithms may be used to solve growing numbers of real-life problems around the globe. Their performance may be connected with the quality of labels used in training. Unfortunately, acquiring good-quality annotations for many tasks is infeasible and/or too expensive to be done in practice. Active learning algorithms may be inadequate when the quality and quantity of labels acquired from experts is not sufficient. Unfortunately, this leads to an undesirable trade-off between annotating individual samples by multiple annotators to increase label quality versus annotating new samples to increase the total number of labeled instances. The quality issues are especially visible in case of highly imbalanced problems, where existing methods might even lead to performance degradation.

### SUMMARY

This disclosure relates generally to the field of training machine learning models, and more specifically to a method and system of automatic determination of which data samples are in need of human annotation to improve a machine learning model.

In one aspect, a method includes determining which objects from a substantial dataset are expected to lead to the largest increase in model quality by applying a samples-selection algorithm using computational capability comprising a processor and/or a memory (e.g., of a processing system and/or a graphics processing unit). The aspect quantifies an informativeness score of data elements in the substantial dataset to determine how likely and/or by what degree data elements will lead to model improvement. The method then automatically determines which data elements of the substantial dataset are in need of human annotation based on a prioritization order derived from the informativeness score and chooses a selected data based on the automatically determining which elements of the substantial dataset are in need of human annotation based on the prioritization order derived from the informativeness score.

The method then matches the selected data to an expert based on a competency and/or a preference of the expert. The method then generates an annotation view of the selected data tailored to the preference and/or the competency of the expert. The expert is able to annotate the selected data through the annotation view. The method adjusts an estimation of competency of the expert based on annotations obtained from the expert. The method then matches an expected unified label based on an artificial intelligence algorithm (e.g., a weighted voting algorithm, a multiple machine learning models voting algorithm, and/or an expectation maximization algorithm).

The method adjusts labels corresponding to annotated elements of the selected data in response to annotations and/or an update to the estimation of competency of the expert. The method determines that the selected data is certain enough by examining the updated competencies of the expert, consensus among multiple experts, and/or analysis through a machine learning model. Finally, the method re-generates the informativeness score for the substantial dataset to generate an input data for a training of the machine learning model, a retraining of the machine learning model, and/or a business intelligence report of an artificial intelligence application. The data that would be most useful for a machine learning process based on the informativeness score may be prioritized for a human review.

The method may determine which objects from the substantial dataset are in need of repeated annotation by applying the samples-selection algorithm, which may include at least one of the following: score of annotation being trustworthy based on human annotators competence estimation on the examined sample; conformance to distribution learned by machine learning model; difficulty score based on representation of the data element. The method may expand a database with annotations assigned by humans to data elements in a manner that the same element may be annotated by multiple human annotators. The method may apply each operation of the method to an annotation verification task to audit whether annotations of other humans are accurate. The method may enable other humans to perform the annotation verification task to audit whether annotations of other humans are accurate. The method may compare annotations of the human and/or an another human with each other, and generate a most-probable annotation based on: (1) annotations assigned by human experts and/or their competencies, (2) predictions of machine learning model trained on annotations, (3) substantial dataset (4) historical data, (5) uncertainty of trained machine learning model, (6) annotations generated from the annotation verification task, (7) predictions of a machine learning model for the annotation verification task, and/or (8) uncertainty of the machine learning model for the annotation verification task.

The method may unify the annotations of the human, the another human, and/or the annotation verifications with each other using a label unification module to create a unified subsequent dataset. The label unification module may select a most probable set of annotations for the single piece of data which was annotated with any one of conflicting annotations and/or adversarial annotations. The method may use the unified subsequent dataset as labels for a training dataset, and/or use compositions of those as the input for training the machine learning model. The method may assess the ununified dataset with an annotation assessment module to determine: an expert competency, whether designations were applied to the annotated data in an adversarial manner, and/or whether a most correct designation was applied to an unannotated data sample. Automatically balance of the experts competency exploration and exploitation of already known experts competencies may be done to optimize obtained annotation quality; where exploration to assess expert competencies might be done by at least one of: creating a new artificial unannotated data sample, choosing sample from the substantial dataset, choosing sample from selected data.

The method may reach an end condition wherein no further annotated data, subsequent annotated data, and/or unified subsequent dataset are inputted into the machine learning model. Creating the unannotated data sample automatically may be based upon the annotated data sample and may operate using the machine learning model to assess an expert competency. The substantial dataset may be an unstructured data that is so voluminous such that traditional data processing methods are unable to discreetly organize the data in a structured schema. The method may analyze the substantial dataset computationally to reveal at least one pattern, trend, and/or association relating to a human behavior and/or a human-computer interaction.

In another aspect, a method includes applying a samples-selection algorithm to determine which objects from a substantial dataset are expected to lead to the largest increase in model quality by using computational capability comprising a processor and/or a memory of a processing system and/or a graphics processing unit, determining how likely and/or by what degree data elements will lead to model improvement through a quantification of an informativeness score of data elements in the substantial dataset, deriving a prioritization order from the informativeness score, automatically determining which data elements of the substantial dataset are in need of human annotation based on the prioritization order, matching a selected data to an expert based on a competency and/or a preference of the expert, and generating an annotation view of the selected data tailored to the preference and/or the competency of the expert through which the expert is able to annotate the selected data.

In yet another aspect, a system includes a computing cluster having at least one of central processors and/or graphics processing units each having a processor and/or a memory, a network, and an annotation server. The annotation server is used to (1) determine which objects from a substantial dataset are expected to lead to the largest increase in model quality by applying a samples-selection algorithm using computational capability comprising a processor and/or a memory of a processing system and/or a graphics processing unit, (2) quantify an informativeness score of data elements in the substantial dataset to determine how likely and/or by what degree data elements will lead to model improvement, (3) determine which data elements of the substantial dataset are in need of human annotation based on a prioritization order derived from the informativeness score, and/or (4) choose a selected data based on the automatically determining which elements of the substantial dataset are in need of human annotation based on the prioritization order derived from the informativeness score.

In addition, the annotation server may match the selected data to an expert based on a competency and/or a preference of the expert, generate an annotation view of the selected data tailored to the preference and/or the competency of the expert through which the expert is able to annotate the selected data, and/or adjust an estimation of competency of the expert based on annotations obtained from the expert. The selected data which has been annotated by the expert may match an expected unified label based on an artificial intelligence algorithm (e.g., a weighted voting algorithm, a multiple machine learning model algorithm, and/or an expectation maximization algorithm). The annotation server may adjust labels corresponding to annotated elements of the selected data in response to annotations and/or an update to the estimation of competency of the expert. The annotation server may determine that the selected data is certain enough by examining the updated competencies of the expert, consensus among multiple experts, and/or analysis through a machine learning model. Then, the annotation server may re-generate the informativeness score for the substantial dataset to generate an input data for a training of the machine learning model, a retraining of the machine learning model, and/or a business intelligence report of an artificial intelligence application.

The annotation server may determine which objects from the substantial dataset are in need of repeated annotation by applying the samples-selection algorithm, which may include at least one of the following: score of annotation being trustworthy based on human annotators competence estimation on the examined sample; conformance to distribution learned by machine learning model; difficulty score based on representation of the data element. The annotation server may expand a database with annotations assigned by humans to data elements in a manner that the same element may be annotated by multiple human annotators. The annotation server may apply each operation of the method to an annotation verification task to audit whether annotations of other humans are accurate. The annotation server may enable other humans to perform the annotation verification task to audit annotations of other humans that are accurate. The annotation server may compare annotations of the human and/or an another human with each other. The annotation server may generate a most-probable annotation.

The annotation server may unify the annotations of the human, the another human, and/or the annotation verifications with each other using a label unification module to create a unified subsequent dataset. The label unification module may select a most probable set of annotations for the single piece of data which was annotated with any one of conflicting annotations and/or adversarial annotations. The annotation server may utilize the unified subsequent dataset as labels for a training dataset, and/or use compositions of those as the input for training the machine learning model.

The methods and systems disclosed herein may be implemented in any means for achieving various aspects, and may be executed in various forms, when executed by a machine, cause the machine to perform any of the operations disclosed herein. Other features will be apparent from the accompanying drawings and from the detailed description that follows.

### BRIEF DESCRIPTION OF THE DRAWINGS

The embodiments of this invention are illustrated by way of example and not limitation in the figures of the accompanying drawings, in which like references indicate similar elements and in which:

FIG. 1 is a process flow diagram that describes an interactive loop of a machine learning model in which a selected data is chosen from a substantial dataset, and in which an informativeness score is iteratively generated, according to one embodiment.

FIG. 2 is a process flow in which data that is most useful to a machine learning process is prioritized for a human review and is determined based on the informativeness score, according to one embodiment.

FIG. 3 is a process flow in which the informativeness score is regenerated, according to one embodiment.

FIG. 4 is a process flow in which other humans are enabled to perform an annotation verification task to audit and ensure other annotations of humans are accurate, according to one embodiment.

FIG. 5 is a process flow in which an end condition is reached wherein no further annotated data, subsequent annotated data, and unified subsequent dataset are inputted into the machine learning model, according to one embodiment.

FIG. 6 is a process flow in which an annotation view is generated of the selected data tailored to a preference and a competency of the expert, according to one embodiment.

FIG. 7 is a conceptual view describing various processes of FIGS. 1-6, according to one embodiment.

FIG. 8 is a visual view describing an active learning cycle of FIGS. 1-6, according to one embodiment.

Other features of the present embodiments will be apparent from the accompanying drawings and from the detailed description that follows.

### DETAILED DESCRIPTION

Example embodiments, as described below, may be used to provide a method and system of automatic determination of which initial data is in need of human annotation when training a machine learning model.

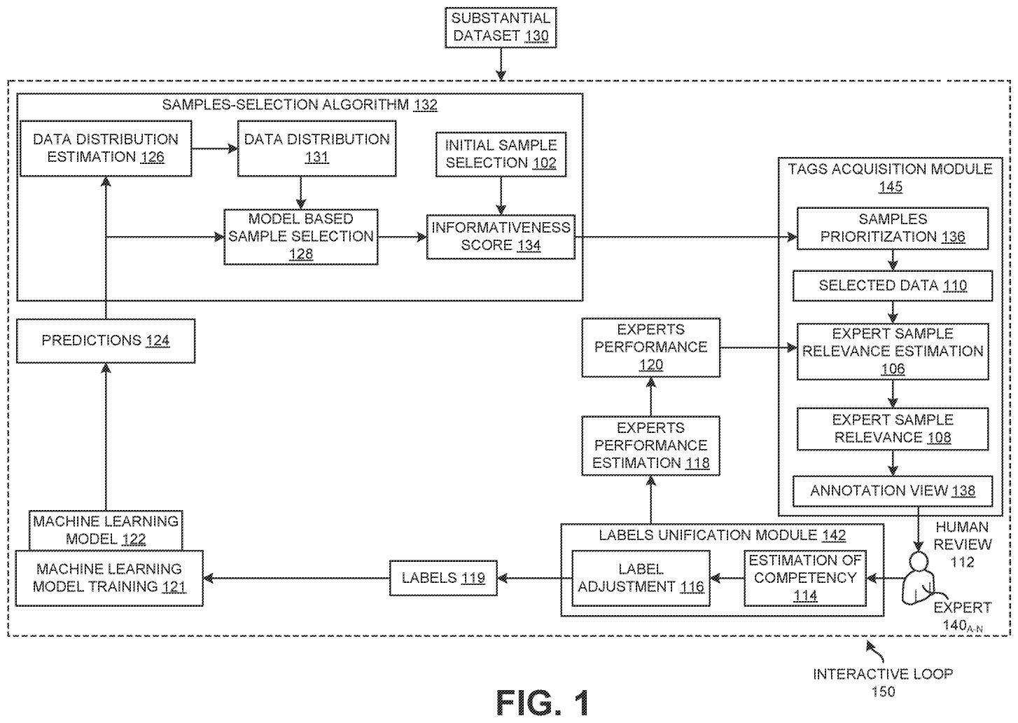

FIG. 1 is a process flow diagram that describes an interactive loop 150 of a machine learning model 122 in which a selected data 110 is chosen from a substantial dataset 130, and in which an informativeness score 134 is iteratively generated, according to one embodiment.

FIG. 1 illustrates an initial sample selection 102, an expert-sample relevance estimation 106, an expert sample relevance 108, a selected data 110, a human review 112, a estimation of competency 114, a label adjustment 116, a experts performance estimation 118, a label(s) 119, a expert(s) performance 120, a machine learning model training 121, a machine learning model 122, a prediction(s) 124, a data distribution estimation 126, a model based sample selection 128, a substantial dataset 130, a data distribution 131, a samples-selection algorithm 132, a informativeness score 134, a sample(s) prioritization 136, a annotation view 138, a expert(s) 140A-N, a label(s) unification module 142, a tags acquisition module 145, and a interactive loop 150.

The initial sample selection 102 may be conducted using a basic random sampling or it may be based on an unsupervised approach whereas, first, a data structure (for example k-d tree) representing the distances between samples is constructed and then the samples are selected as a set of the most representative samples according to that structure. A batch of samples may be created by basing on different ways of selecting and assessing samples combined together, taking into account, for example, both their data representatives and their uncertainty measurements corresponding to the previous versions of machine learning models. The expert-sample relevance estimation 106 may be based on the history of performance of the expert in regard to similar samples up to the present point and on a correspondence between the importance of particular samples to the overall process and the level of experience of particular experts. The expert sample relevance 108 may be derived by a matching algorithm wherein the goal is to assign particular samples to particular experts in such a way that the overall score of the resulting expert-sample relevances is maximized.

The selected data 110 may be understood as the finally selected set of samples, wherein that set can be stored in memory, on a disk, and/or in the form of pointers to a bigger data set stored on a disk. It may also be possible that the samples in the set are stored in two forms, wherein one of them is optimized for the purpose of displaying data to the experts and the second form is optimized for the machine learning process. The human review 112 may be conducted based on human interaction with the GUI interface, wherein the experts can see single samples at a time and/or pairs of samples or larger collections of samples, wherein the corresponding annotation task may be to analyze a single sample, to choose a sample from the pair of samples, and/or to rank a larger collection of samples. The estimation of competency 114 may be based on the examination of consistency of labeling actions of the given expert on a set of similar samples and/or on comparison of the expert's annotation with the annotations of other experts on the same sample and/or similar samples.

The label adjustment 116 may be a procedure assigning to each annotated object a set of labels resulting from the unification algorithm if the confidence of the labels is on a required level. The experts performance estimation 118 may be a procedure estimating F₁-score of expert annotations according to unified labels for every class in classification problem. The label(s) 119 may be a categorical label, a binary classification, a time series label, a multi-class classification, a regression, and/or a multi-label classification. The experts performance 120 may be F₁-scores of experts' annotations for every class in classification problem. The machine learning model training 121 may be a neural network fine-tuning procedure and/or tree ensemble training procedure. The machine learning model 122 may be a neural network.

The predictions 124 may be a probability of belonging to a particular class assigned by a machine learning model for each sample. The data distribution estimation 126 may be a procedure estimating the probability density function using the trained machine learning model. The model based sample selection 128 may be a linear combination of the diversity score and/or entropy of probabilities scaled according to data distribution. The data distribution 131 may be an approximation of probability density function via prediction of machine learning model 122. The samples-selection algorithm 132 may be a procedure computing the informativeness score 134 based on supervised machine learning model when one is available and may use an unsupervised learning initial sample selection otherwise. The substantial dataset 130 may be image data, text data, tabular data, video data, time series data, logs data, compound data.

The informativeness score 134 may be an uncertainty score such as an entropy of probabilities returned by the model for each of the samples and may be combined with a representativeness score, such as the average distance to the five most similar samples in the substantial dataset 130. The sample(s) prioritization 136 may be a decreasing order according to the informativeness score 134. The annotation view 138 may be a widget presenting a video and/or the video transcription, when video might be adjusted to color blind viewing expert. The expert(s) 140A-N may be cybersecurity operation center analysts. The label(s) unification module 142 may be a composition of expert competencies estimation with expectation maximization algorithm and labels adjustment according to estimated labels. The tags acquisition module 145 may be a process wherein one-hundred samples with largest informativeness scores 134 are selected and may be subsequently assigned to experts in real time when experts 140 approach the system in a manner that the most relevant sample, from not yet tagged selected data, is presented to the expert 140. The interactive loop 150 may be for example a dog species annotation loop, where substantial dataset 130 is a dataset with dog pictures, experts 140A-N are the users of dog breeders forum and machine learning model 122 is a neural network classifying breed of the dog on the picture passed as an input.

According to one or more embodiments, the substantial dataset 130 is input into the samples-selection algorithm 132 wherein the initial sample selection 102 occurs, as described in FIG. 1. Next, an informativeness score 134 is quantified and used to select one or more batches of samples. Next, the informativeness score 134 is input into the tags acquisition module 145 which determines the sample(s) prioritization 136. The sample(s) prioritization is used to determine the selected data 110, which is then used to determine the expert sample relevance estimation 106 and the expert sample relevance 108. Next, the tags acquisition module 145 produces an annotation view 138 which allows for data to become available for human review 112 by expert(s) 140A-N. After human review 112, the label(s) unification module 142 may produce an estimation of competency 114 followed by a label adjustment 116 wherein data labels may be unified. After the data has been unified in the label(s) unification module 142, the unified data is used to assess the expert(s) performance estimation 118. The expert(s) performance 120 may then be used as an input for the expert sample relevance estimation 106 in the tags acquisition module 145.

After the label adjustment 116, label(s) 119 are added to the data and are subsequently used for machine learning model training 121. After training machine learning model training 121, the machine learning model 122 creates predictions 124 which are input into the samples-selection algorithm 132 wherein a data distribution estimation 126 is made. Next, data distribution 131 is used for model based sample selection 128, which then creates a new informativeness score 134, and the loop is repeated again, according to one embodiment.

In one embodiment, a method includes determining which objects from a substantial dataset 130 are expected to lead to the largest increase in model quality by applying a samples-selection algorithm 132 using computational capability comprising a processor 818 and/or a memory 820 (e.g., of a processing system (e.g., microprocessors 816) and/or a graphics processing unit(s) 814). The embodiment quantifies an informativeness score 134 of data elements in the substantial dataset 130 to determine how likely and/or by what degree data elements will lead to model improvement.

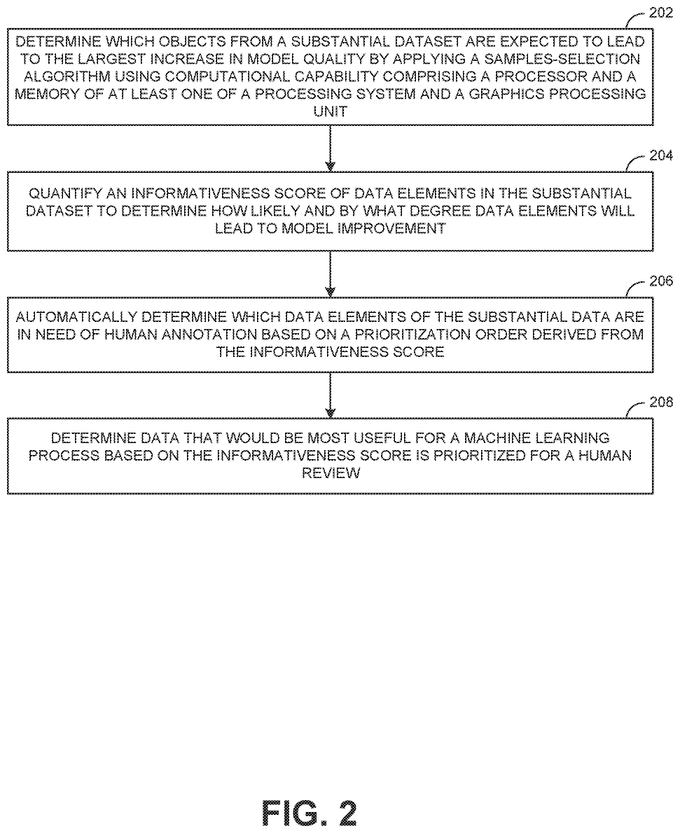

FIG. 2 is a process flow in which data that is most useful to a machine learning process is prioritized for a human review 112 and is determined based on the informativeness score 134, according to one embodiment. In operation 202, a determination may be made of which objects from a substantial dataset 130 are expected to lead to the largest increase in model quality by applying a samples-selection algorithm 132 using computational capability comprising a processor 818 and a memory 820 of at least one of a processing system and a graphics processing unit. In operation 204, an informativeness score 134 of data elements in the substantial dataset 130 may be quantified to determine how likely and by what degree data elements will lead to model improvement. In operation 206, it may be automatically determined which data elements of the substantial dataset 130 are in need of human annotation based on a sample(s) prioritization 136 derived from the informativeness score 134. In operation 208, data that would be most useful for a machine learning process may be determined based on the informativeness score 134 is prioritized for a human review 112.

The method then may automatically determine which data elements of the substantial dataset 130 are in need of human annotation based on a sample(s) prioritization 136 derived from the informativeness score 134 and chooses a selected data 110 based on the automatically determining which elements of the substantial dataset 130 are in need of human annotation based on the sample(s) prioritization 136 derived from the informativeness score 134.

The method then matches the selected data 110 to an expert based on a competency and/or a preference of the expert (e.g., any of the humans 140A-N). The method then generates an annotation view 138 of the selected data 110 tailored to the preference and/or the competency of the expert. The expert is able to annotate the selected data 110 through the annotation view 138. The method adjusts an estimation of competency 114 of the expert 140 based on whether the selected data 110 which has been annotated by the expert 140. The method then matches an expected unified label based on an artificial intelligence algorithm (e.g., a weighted voting algorithm, a multiple machine learning models voting algorithm, and/or an expectation maximization algorithm).

The method adjusts labels 119 corresponding to annotated elements of the selected data 110 in response to annotations and/or an update to the estimation of competency 114 of the expert 140. The method determines that the selected data 110 is certain enough by examining the updated competencies of the expert, consensus among multiple experts, and/or analysis through a machine learning model 122.

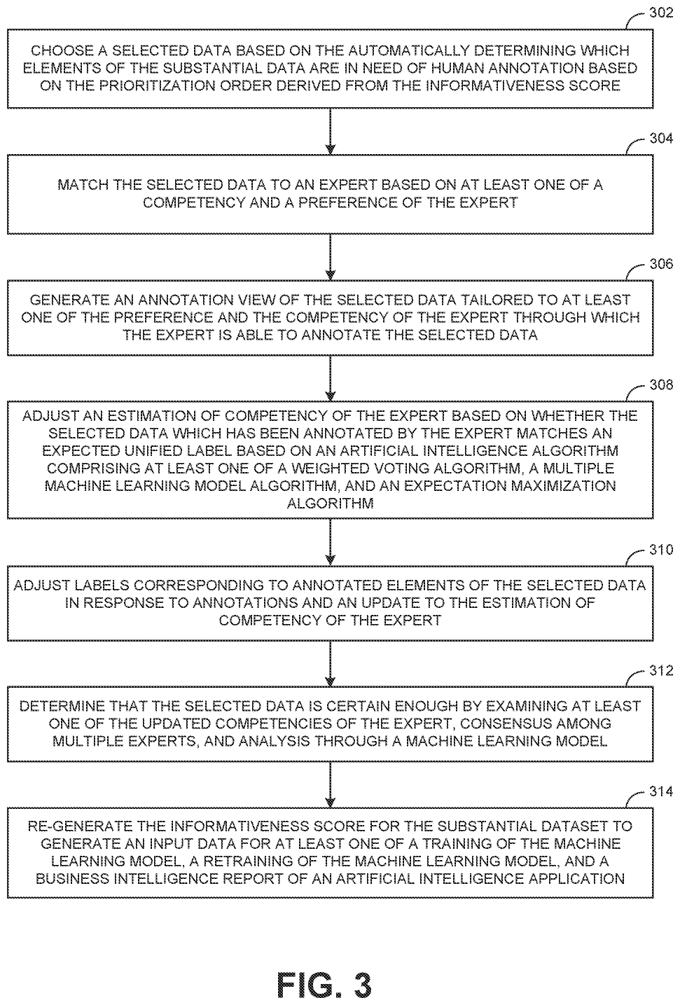

FIG. 3 is a process flow in which the informativeness score 134 is regenerated, according to one embodiment. In operation 302, a selected data 110 based on automatically determining which elements of the substantial dataset 130 are in need of human annotation based on the sample(s) prioritization 136 derived from the informativeness score 134 may be chosen. In operation 304, the selected data 110 may be matched to an expert 140 based on at least one of a competency and a preference of the expert 140. In operation 306, an annotation view 138 of the selected data 110 tailored to at least one of the preference and the competency of the expert 140 may be generated through which the expert 140 is able to annotate the selected data 110.

In operation 306 an estimation of competency 114 of the expert 140 may be adjusted based on whether the selected data 110 which has been annotated by the expert 140 matches an expected unified label based on an artificial intelligence algorithm comprising at least one of a weighted voting algorithm, a multiple machine learning model 122 algorithm, and an expectation maximization algorithm. In operation 308, labels corresponding to annotated elements of the selected data 110 may be adjusted in response to annotations and an update to the estimation of competency 114 of the expert 140. In operation 310, it may be determined that the selected data 110 is certain enough by examining at least one of the updated competencies of the expert 140, consensus among multiple expert 140s, and analysis through a machine learning model 122. In operation 312, the informativeness score 134 for the substantial dataset 130 may be regenerated to generate an input data for at least one of a training of the machine learning model 122, a retraining of the machine learning model 122, and a business intelligence report of an artificial intelligence application.

Finally, the method re-generates the informativeness score 134 for the substantial dataset 130 to generate an input data for a training 121 of the machine learning model 122, a retraining of the machine learning model 122, and/or a business intelligence report of an artificial intelligence application. The data that would be most useful for a machine learning process based on the informativeness score 134 may be prioritized for a human review 112.

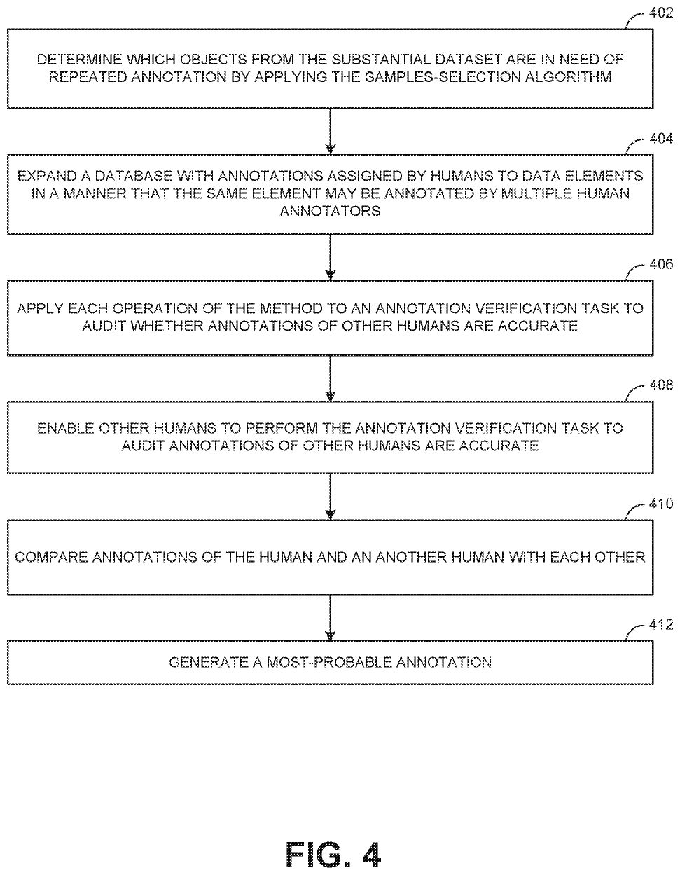

FIG. 4 is a process flow in which other humans are enabled to perform an annotation verification task to audit and ensure other annotations of humans are accurate, according to one embodiment. In operation 402, which objects from the substantial dataset 130 are in need of repeated annotation may be determined by applying the samples-selection algorithm 132. In operation 404 a database with annotations assigned by humans to data elements may be expanded in a manner that the same element may be annotated by multiple human annotators. In operation 406, each operation of the method may be applied to an annotation verification task to audit whether annotations of other humans are accurate. In operation 408, other humans may be enabled to perform the annotation verification task to audit if annotations of other humans are accurate. In operation 410, annotations of the human and another human may be compared with each other. In operation 412, a most-probable annotation may be generated.

The method may determine which objects from the substantial dataset 130 are in need of repeated annotation by applying the samples-selection algorithm 132, which may include at least one of the following: score of annotation being trustworthy based on human annotators competence estimation on the examined sample; conformance to distribution learned by machine learning model; difficulty score based on representation of the data element. The method may expand a database with annotations assigned by humans to data elements in a manner that the same element may be annotated by multiple human annotators. The method may apply each operation of the method to an annotation verification task to audit whether annotations of other humans are accurate. The method may enable other humans to perform the annotation verification task to audit whether annotations of other humans are accurate. The method may compare annotations of the human 140A and/or an another human 140B with each other, and generate a most-probable annotation based on: (1) annotations assigned by human experts and/or their competencies, (2) predictions of machine learning model 122 trained on annotations, (3) substantial dataset 130 (4) historical data, (5) uncertainty of trained machine learning model 122, (6) annotations generated from the annotation verification task, (7) predictions of a machine learning model 122 for the annotation verification task, and/or (8) uncertainty of the machine learning model 122 for the annotation verification task.

The method may unify the annotations of the human 140A, the another human 140B, and/or the annotation verifications with each other using a label(s) unification module 142 to create a unified subsequent dataset. The label(s) unification module 142 may select a most probable set of annotations for the single piece of data which was annotated with any one of conflicting annotations and/or adversarial annotations. The method may use the unified subsequent dataset as labels 119 for a training dataset, and/or use compositions of those as the input for training 121 the machine learning model 122.

The method may assess the ununified dataset with an annotation assessment module to determine: an expert competency, whether designations were applied to the annotated data in an adversarial manner, and/or whether a most correct designation was applied to an unannotated data sample. Automatic balance of the experts competency exploration and exploitation of already known experts competencies may be done to optimize obtained annotation quality; where exploration to assess expert competencies might be done by at least one of: creating a new artificial unannotated data sample, choosing sample from the substantial dataset 130, choosing sample from selected data.

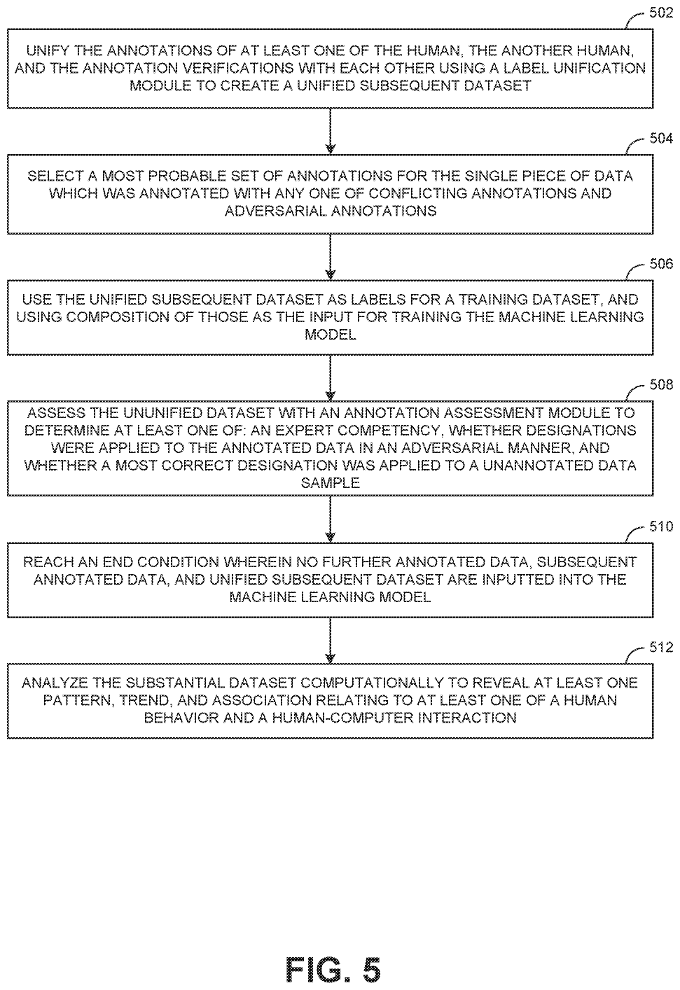

FIG. 5 is a process flow in which an end condition is reached wherein no further annotated data, subsequent annotated data, and unified subsequent dataset are inputted into the machine learning model 122, according to one embodiment. In operation 502, the annotations of at least one of the human, the another human, and the annotation verifications may be unified with each other using a label unification module 142 to create a unified subsequent dataset. In operation 504 a most probable set of annotations may be selected for the single piece of data which was annotated with any one of conflicting annotations and adversarial annotations. In operation 506, the unified subsequent dataset may be used as labels for a training dataset, and using composition of those as the input for training the machine learning model 122. In operation 508, the ununified dataset may be assessed with an annotation assessment module to determine at least one of: an expert 140 competency, whether designations were applied to the annotated data in an adversarial manner, and whether a most correct designation was applied to a unannotated data sample. In operation 510, an end condition may be reached wherein no further annotated data, subsequent annotated data, and unified subsequent dataset are inputted into the machine learning model 122. In operation 512, the substantial dataset 130 may be analyzed computationally to reveal at least one pattern, trend, and association relating to at least one of a human behavior and a human-computer interaction.

The method may reach an end condition wherein no further annotated data, subsequent annotated data, and/or unified subsequent dataset are inputted into the machine learning model 122. Creating the unannotated data sample automatically may be based upon the annotated data sample and may operate using the machine learning model 122 to assess an expert competency. The substantial dataset 130 may be an unstructured data that is so voluminous such that traditional data processing methods are unable to discreetly organize the data in a structured schema. The method may analyze the substantial dataset 130 computationally to reveal at least one pattern, trend, and/or association relating to a human behavior and/or a human-computer interaction.

In another embodiment, a method includes applying a samples-selection algorithm 132 to determine which objects from a substantial dataset 130 are expected to lead to the largest increase in model quality by using computational capability comprising a processor 818 and/or a memory 820 of a processing system (e.g., microprocessors 816) and/or a graphics processing unit(s) 814, determining how likely and/or by what degree data elements will lead to model improvement through a quantification of an informativeness score 134 of data elements in the substantial dataset 130, deriving a sample(s) prioritization 136 derived from the informativeness score 134, automatically determining which data elements of the substantial dataset 130 are in need of human annotation based on the sample(s) prioritization 136, matching a selected data 110 to an expert based on a competency and/or a preference of the expert, and generating an annotation view 138 of the selected data 110 tailored to the preference and/or the competency of the expert through which the expert is able to annotate the selected data 110.

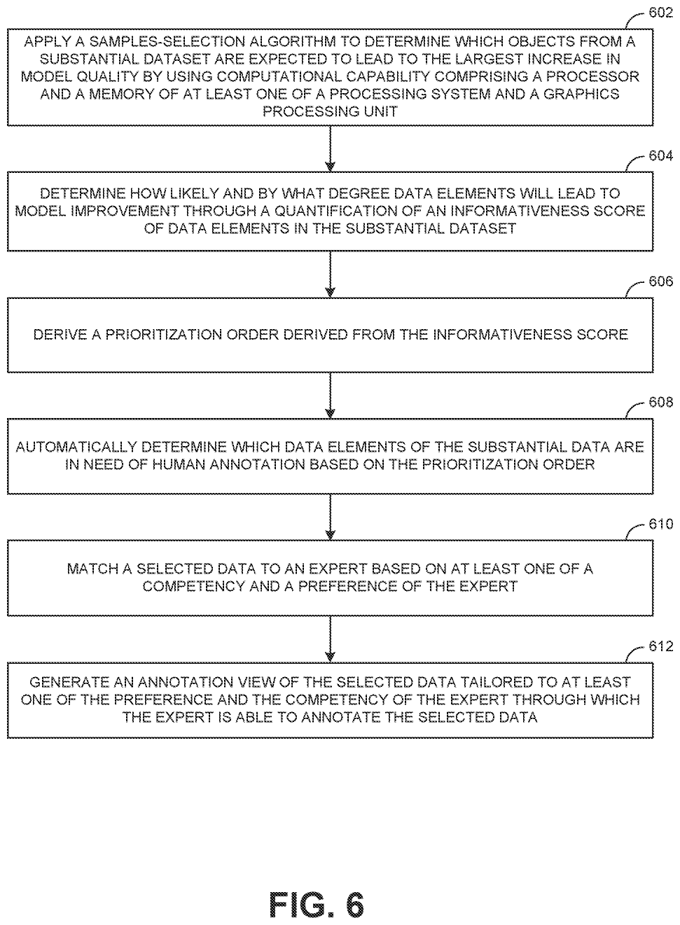

FIG. 6 is a process flow in which an annotation view 138 is generated of the selected data 110 tailored to a preference and a competency of the expert, according to one embodiment. In operation 602, a samples-selection algorithm 132 may be applied to determine which objects from a substantial dataset 130 are expected to lead to the largest increase in model quality by using computational capability comprising a processor 818 and a memory 820 of at least one of a processing system and a graphics processing unit. In operation 604, how likely and by what degree data elements will lead to model improvement may be determined through a quantification of an informativeness score 134 of data elements in the substantial dataset 130. In operation 606, a sample(s) prioritization 136 may be derived from the informativeness score 134. In operation 608, which data elements of the substantial dataset 130 are in need of human annotation may be automatically determined based on the sample(s) prioritization 136. In operation 610, a selected data 110 may be matched to an expert 140 based on at least one of a competency and a preference of the expert 140. In operation 612, an annotation view 138 of the selected data 110 tailored to at least one of the preference and the competency of the expert 140 through which the expert 140 is able to annotate the selected data 110 may be generated.

In yet another embodiment, a system includes a computing cluster 812 having at least one of microprocessor(s) 818 and/or graphics processing unit(s) 814 each having a processor 818 and/or a memory 820, a network, and an annotation server. The annotation server is used to (1) determine which objects from a substantial dataset 130 are expected to lead to the largest increase in model quality by applying a samples-selection algorithm 132 using computational capability comprising a processor 818 and/or a memory 820 of a processing system (e.g., microprocessors 816) and/or a graphics processing unit(s) 814, (2) quantify an informativeness score 134 of data elements in the substantial dataset 130 to determine how likely and/or by what degree data elements will lead to model improvement, (3) determine which data elements of the substantial dataset 130 are in need of human annotation based on a sample(s) prioritization 136 derived from the informativeness score 134, and/or (4) choose a selected data 110 based on the automatically determining which elements of the substantial dataset 130 are in need of human annotation based on the sample(s) prioritization 136 derived from the informativeness score 134.

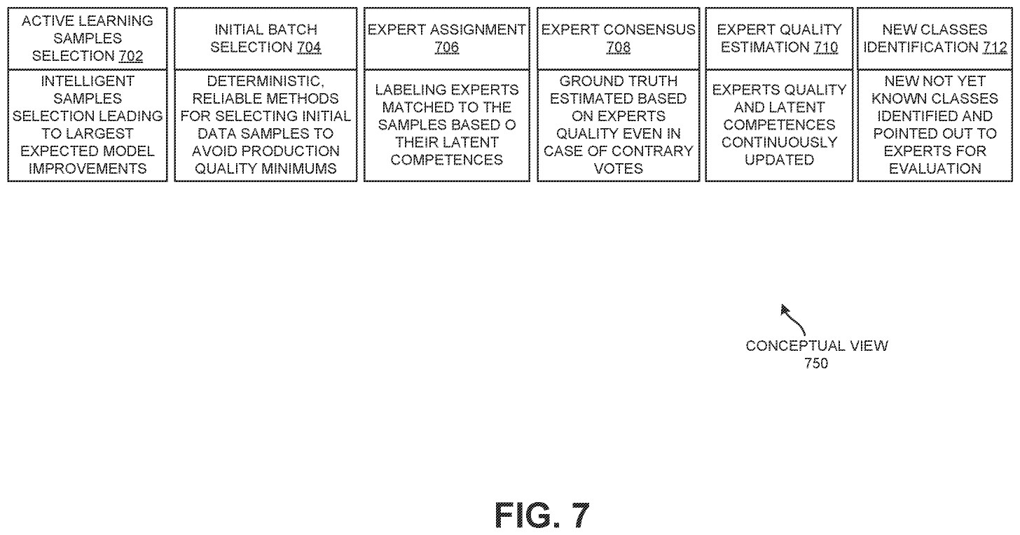

FIG. 7 is a conceptual view 750 describing various processes of FIGS. 1-6, according to one embodiment. FIG. 7 illustrates a active learning samples selection 702, a initial batch selection 704, a expert assignment 706, a expert consensus 708, a expert quality estimation 710, and a new classes identification 712.

The active learning samples selection 702 may include intelligent samples selection leading to largest expected model improvements. The initial batch selection 704 may include deterministic, reliable methods for selecting initial data samples to avoid production quality minimums. The expert assignment 706 may include labeling experts matched to the samples based on their latent competences. The expert consensus 708 may include ground truth estimated based on expert quality even in case of contrary votes. The expert quality estimation 710 may include wherein the experts quality and latent competences continuously updated. The new classes identification 712 may include new not yet known classes identified and pointed out to experts for evaluation.

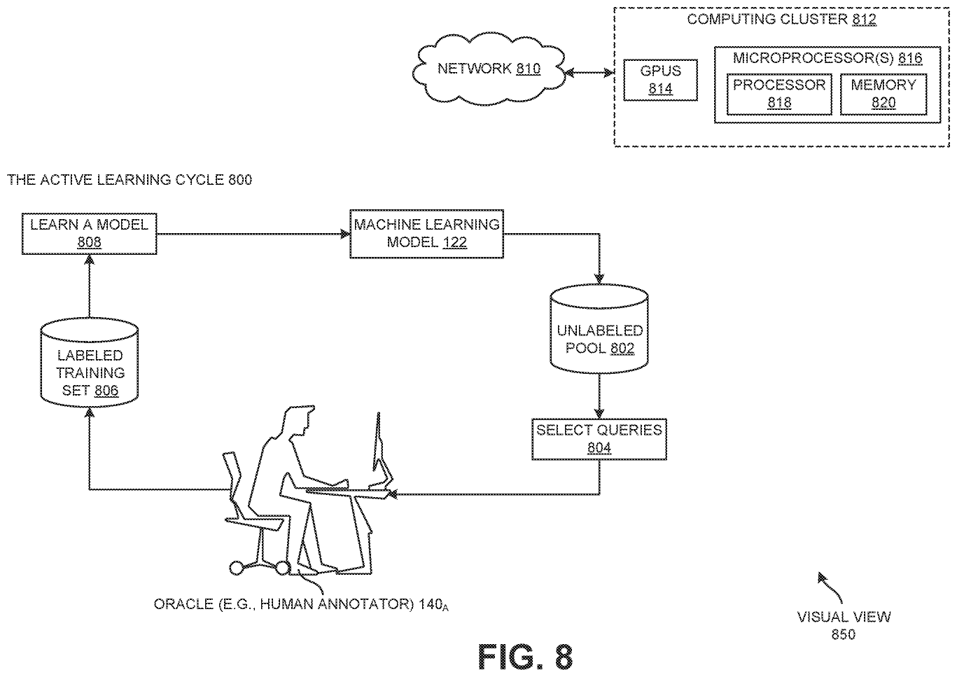

FIG. 8 is a visual view describing an active learning cycle of FIGS. 1-6, according to one embodiment. FIG. 8 illustrates a active learning cycle 800 comprising the machine learning model 122, a oracle(s) 140A, an unlabeled pool 802, a select queries 804, a labeled training set 806, a learn a model 808, a network 810, a computing cluster 812, a GPU(s) 814, a micro processor(s) 816, a processor(s) 818, and a memory 820.

The active learning cycle 800 may be a cybersecurity threat annotation cycle. The machine learning model 122 may be a gradient boosting tree ensemble model with cybersecurity logs aggregations passed as an input predicting whether a threat alert should be raised for input logs. The oracle(s) (e.g. human expert) 140A may be security operation center analysts. The unlabeled pool 802 may be a large set of log aggregations, where aggregations have been prepared according to the IP address of the machines they come from. The select queries 804 may be the selected data samples via informativeness score 134 prioritization, obtained with entropy based uncertainty. The labeled training set 806 may be logs aggregations which have been manually viewed by analysts. The learn a model 808 may be a process of training the gradient boosting tree ensemble.

The network 810 may be a collection of interconnected computers and other devices that are linked together to facilitate communication, data sharing, and resource sharing between them and/or may allow computers and devices to exchange information and collaborate, enabling users to access shared resources, communicate with each other, and utilize distributed services. The computing cluster 812 may be a group of interconnected computers or servers that work together to perform computational tasks and may be designed to provide high performance and/or scalability, allowing large-scale processing and/or handling of complex tasks that a single computer may not be capable of handling efficiently. The GPU(s) 814 may be specialized processors primarily designed for rendering and/or manipulating images, videos, and/or graphics in real-time and may be used for accelerating computer graphics in multimedia applications.

The microprocessor(s) 816 may be integrated circuits that contain the core processing capabilities of a computer system, responsible for executing instructions and performing arithmetic, logical, control, and/or input/output operations and may serve as the brain of a computer, interpreting and/or executing instructions to perform tasks and manipulate data. The processor(s) 818 may refer to the Central Processing Units (CPUs) that serve as the core computational units within computing systems. The memory 820 may refer to the electronic storage space in a computer system where data and/or instructions are stored for immediate access by the processor and may play a crucial role in the functioning of a computer, allowing for the temporary storage and retrieval of data during program execution.

In FIG. 8, the active learning cycle 800 may include the machine learning model 122 which may produce an unlabeled pool 802 of data, which may include select queries 804, which are then sent to the expert(s) 140A-N for labeling. This labeled data may be a labeled training set 806 which may be used to learn a model 808, which may then be input into the machine learning model 122. This active learning cycle 800 may be computed using a computing cluster 812 which may comprise microprocessor(s) 816 including a processor 818 and/or a memory 820. The computing cluster 812 may further comprise GPUs 814. The computing cluster may communicate information and/or data over the network 810.

Uncertainty measurement for active learning over imbalanced data may be described in the embodiments of FIGS. 1-8. Acquisition of data labels with production quality may be expensive prior to the embodiments of FIGS. 1-8. In contrast, data may be abundant and easy to obtain (e.g., sensor networks, IoT, process logs, social media, and/or video streams). Class distribution may have better balance thanks to the embodiments of FIGS. 1-8. The embodiments of FIGS. 1-8 may deploy a set of algorithms that iteratively query the oracle (e.g., experts) asking to label indicated samples to obtain a better machine learning model.

The embodiments of FIGS. 1-8 may solve the problem of efficient machine learning model training 121 through effective interaction with experts, i.e. experts' domain knowledge sensitive. The machine learning model 122 may be used as a product itself (to guide business decisions) and/or to label the data that will be used in decision making. The innovation present in the embodiments of FIGS. 1-8 may be twofold: the sampling methods utilize information about the data distribution that may be estimated using the model being trained and the observations that are selected for tagging are specially selected for the expert. The expert-sample selection may optimize the labels quality and at the same time to maximize the system's knowledge about the expert which is used for the selection process.

The embodiments of FIGS. 1-8 may operate on the classification task on image, text and/or tabular data modalities. The embodiments of FIGS. 1-8 may apply to one or more modalities and to one or more machine learning tasks. The embodiments of FIGS. 1-8 may include but are not limited to: (1) continuous and automatic adjustment of the data representation used in the system; (2) continuous and automatic adjustment of the sampling criteria; and (3) continuous and automatic adjustment of the model being trained

The embodiments of FIGS. 1-8 may augment products and solutions with a tangible AI-based value proposition for clients. Management of internal corporate Security Operations (SecOps) and/or cybersecurity services may have challenges that may have been amplified by the COVID-19 pandemic. The embodiments of FIGS. 1-8 may help a business expand the ability to solve incidents without headcount increase.

Human experts may be both the gem and the bottleneck of cybersecurity operations. While there may be plenty of tools for gathering and analyzing the ever-increasing amounts of data, it is the human expert who may have the ability to select and interpret the relevant information, while taking into account the situational context. Yet, SOC experts' decision-making process may be difficult to codify. Their tasks may be complex, and they may be often highly specialized with respect to attack types. The embodiments of FIGS. 1-8 may enable creation of Artificial Experts: software agents that may perceive the environment in which they are situated (including SIEM data, human expert activities, etc.) and/or react to the events occurring in that environment (e.g. notify the human experts, surface examples of similar incidents from the past, etc.). Their decisions may depend on the predictions of machine learning models trained on data collected from observing the human experts at work.

On 10% of the data, the embodiments of FIGS. 1-8 may achieve over 80% of the quality of the model trained on 100% of the data. The method of extracting expert knowledge may reach over 110% of the quality the best expert. The embodiments of FIGS. 1-8 may achieve a stable result and the quality of the 80th percentile (or higher) of the quality distribution of the (unstable) baseline method.

For example, Acme Bank may have a cybersecurity department wherein human experts annotate data sets of multimodal data (e . . . g, visual, textual, handwritten, photographic, video, audio) in order to train their cybersecurity machine learning model. Thanks to the embodiments of FIGS. 1-8, human annotation might only be required for a small sample of data, with the balance being done by machine learning. In addition, the various embodiments of FIGS. 1-8 may automatically identify anomalies in human annotations and pass them on to secondary review.

For example, the embodiments of FIGS. 1-8 choose the most beneficial and substantial datasets to be provided to the human annotator for Acme Bank, based on the annotator's skills and preferences. For example, some annotators working with Acme Bank may be better at labeling forged signatures, while others might be better at facial recognition. Once the data is annotated, if the machine learning model determines that the labeled data does not fit a predicted norm, the annotator's credibility score may be impacted (automatically), and the review might pass to an expert team for secondary review thanks to the embodiments of FIGS. 1-8.

These substantial datasets are expected to lead to the largest increase in model quality by applying a samples-selection algorithm. This samples-selection algorithm quantifies an informativeness score of data elements that determines how likely and to what degree the data elements will improve the model and then automatically determines which data elements from the substantial dataset are in need of human annotation based on a prioritization order derived from the informativeness score wherein data that would be most useful for a machine learning process based on the informativeness score is prioritized for a human review. Selected data may then be chosen based on the automatically determining which elements of the substantial dataset are in need of human annotation based on the prioritization order derived from the informativeness score. This selected data is then matched to a corresponding expert based on either the competency of the preference of the human expert.

The selected data is then presented to the expert in an annotation view wherein the expert can annotate the data. As the expert annotates and the data is used to train the model, the competency of the expert is estimated using any one of a weighted voting algorithm, a multiple machine learning models voting algorithm, and/or an expectation maximization algorithm. The embodiments of FIGS. 1-8 then adjust the labels corresponding to annotated elements of the selected data in response to annotations and an update to the estimation of competency of the expert. The embodiments of FIGS. 1-8 then determine that the selected data is certain enough by examining at least one of the updated competencies of the expert, consensus among multiple experts, and analysis through a machine learning model. The embodiments of FIGS. 1-8 then regenerate the informativeness score for the substantial dataset to generate an input data for at least one of a training of the machine learning model, a retraining of the machine learning model, and a business intelligence report of an artificial intelligence application

Although the present embodiments have been described with reference to specific example embodiments, it will be evident that various modifications and changes may be made to these embodiments without departing from the broader spirit and scope of the various embodiments.

A number of embodiments have been described. Nevertheless, it will be understood that various modifications may be made without departing from the spirit and scope of the claimed invention. In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

It may be appreciated that the various systems, methods, and apparatus disclosed herein may be embodied in a machine-readable medium and/or a machine accessible medium compatible with a data processing system (e.g., a computer system), and/or may be performed in any order.

The structures and modules in the figures may be shown as distinct and communicating with only a few specific structures and not others. The structures may be merged with each other, may perform overlapping functions, and may communicate with other structures not shown to be connected in the figures. Accordingly, the specification and/or drawings may be regarded in an illustrative rather than a restrictive sense.

1. A method, comprising:
determining which objects from a substantial dataset are expected to lead to the largest increase in model quality by applying a samples-selection algorithm using computational capability comprising a processor and a memory of at least one of a processing system and a graphics processing unit;
quantifying an informativeness score of data elements in the substantial dataset to determine how likely and by what degree data elements will lead to model improvement;
automatically determining which data elements of the substantial dataset are in need of human annotation based on a prioritization order derived from the informativeness score,
wherein data that would be most useful for a machine learning process based on the informativeness score is prioritized for a human review;
choosing a selected data based on the automatically determining which elements of the substantial dataset are in need of human annotation based on the prioritization order derived from the informativeness score;
matching the selected data to an expert based on at least one of a competency and a preference of the expert;
generating an annotation view of the selected data tailored to at least one of the preference and the competency of the expert through which the expert is able to annotate the selected data;
adjusting an estimation of competency of the expert based on annotations obtained from the expert, wherein the annotations to match an expected unified label based on an artificial intelligence algorithm comprising at least one of a weighted voting algorithm, a multiple machine learning models voting algorithm, and an expectation maximization algorithm;
adjusting labels corresponding to annotated elements of the selected data in response to annotations and an update to the estimation of competency of the expert;
determining that the selected data is certain enough by examining at least one of the updated competencies of the expert, consensus among multiple experts, and analysis through a machine learning model; and
re-generating the informativeness score for the substantial dataset to generate an input data for at least one of a training of the machine learning model, a retraining of the machine learning model, and a business intelligence report of an artificial intelligence application.

2. The method of claim 1 further comprising:
determining which objects from the substantial dataset are in need of repeated annotation by applying the samples-selection algorithm, which may include at least one of the following:
score of annotation being trustworthy based on human annotators competence estimation on the examined sample; conformance to distribution learned by machine learning model; difficulty score based on representation of the data element.

3. The method of claim 2 further comprising:
expanding a database with annotations assigned by humans to data elements in a manner that the same element may be annotated by multiple human annotators.

4. The method of claim 1 further comprising applying each operation of the method to an annotation verification task to audit whether annotations of other humans are accurate.

5. The method of claim 4 further comprising:
enabling other humans to perform the annotation verification task to audit annotations of other humans are accurate;
comparing annotations of the human and an another human with each other; and
generating a most-probable annotation based on at least one of:
annotations assigned by human experts and their competencies,
predictions of machine learning model trained on at least one of annotations, substantial data, and historical data,
uncertainty of trained machine learning model,
annotations generated from the annotation verification task,
predictions of a machine learning model for the annotation verification task, and
uncertainty of the machine learning model for the annotation verification task.

6. The method of claim 5 further comprising:
unifying the annotations of at least one of the human, the another human, and the annotation verifications with each other using a label unification module to create a unified subsequent dataset, and
wherein the label unification module selects a most probable set of annotations for the single piece of data which was annotated with any one of conflicting annotations and adversarial annotations.

7. The method of claim 6 further comprising:
using the unified subsequent dataset as labels for a training dataset, and using composition of those as the input for training the machine learning model.

8. The method of claim 7 further comprising:
assessing the ununified dataset with an annotation assessment module to determine at least one of: an expert competency, whether designations were applied to the annotated data in an adversarial manner, and whether a most correct designation was applied to an unannotated data sample.

9. The method of claim 8 further comprising:
reaching an end condition wherein no further annotated data, subsequent annotated data, and unified subsequent dataset are inputted into the machine learning model.

10. The method of claim 9:
wherein to automatically balance the experts competency exploration and exploitation of already known experts competencies to optimize obtained annotation quality; where exploration to assess expert competencies might be done by at least one of: creating a new artificial unannotated data sample, choosing sample from the substantial dataset, choosing sample from selected data.

11. The method of claim 10:
wherein the substantial dataset is an unstructured data that is so voluminous that traditional data processing methods are unable to discreetly organize the data in a structured schema.

12. The method of claim 11 further comprising:
analyzing the substantial dataset computationally to reveal at least one pattern, trend, and association relating to at least one of a human behavior and a human-computer interaction.

13. A method, comprising:
applying a samples-selection algorithm to determine which objects from a substantial dataset are expected to lead to the largest increase in model quality by using computational capability comprising a processor and a memory of at least one of a processing system and a graphics processing unit;
determining how likely and by what degree data elements will lead to model improvement through a quantification of an informativeness score of data elements in the substantial dataset;
deriving a prioritization order from the informativeness score;
automatically determining which data elements of the substantial dataset are in need of human annotation based on the prioritization order;
matching a selected data to an expert based on at least one of a competency and a preference of the expert; and
generating an annotation view of the selected data tailored to at least one of the preference and the competency of the expert through which the expert is able to annotate the selected data.

14. The method of claim 13 further comprising:
choosing the selected data based on the automatically determining which elements of the substantial dataset are in need of human annotation based on the prioritization order derived from the informativeness score; adjusting an estimation of competency of the expert based on annotations obtained from the expert, wherein the annotations to match an expected unified label based on an artificial intelligence algorithm comprising at least one of a weighted voting algorithm, a multiple machine learning models voting algorithm, and an expectation maximization algorithm;
adjusting labels corresponding to annotated elements of the selected data in response to annotations and an update to the estimation of competency of the expert;
determining that the selected data is certain enough by examining at least one of the updated competencies of the expert, consensus among multiple experts, and analysis through a machine learning model; and
re-generating the informativeness score for the substantial dataset to generate an input data for at least one of a training of the machine learning model, a retraining of the machine learning model, and a business intelligence report of an artificial intelligence application,
wherein data that would be most useful for a machine learning process based on the informativeness score is prioritized for a human review.

15. The method of claim 14 further comprising:
expanding a database with annotations assigned by humans to data elements in a manner that the same element may be annotated by multiple human annotators; and
applying each operation of the method to an annotation verification task to audit whether annotations of other humans are accurate.

16. The method of claim 15 further comprising:
enabling other humans to perform the annotation verification task to audit annotations of other humans are accurate;
comparing annotations of the human and an another human with each other; and
generating a most-probable annotation based on at least one of:
annotations assigned by human experts and their competencies,
predictions of machine learning model trained on at least one of annotations, substantial data, and historical data,
uncertainty of trained machine learning model,
annotations generated from the annotation verification task,
predictions of a machine learning model for the annotation verification task, and
uncertainty of the machine learning model for the annotation verification task.

17. The method of claim 16 further comprising:
unifying the annotations of at least one of the human, the another human, and the annotation verifications with each other using a label unification module to create a unified subsequent dataset, and
wherein the label unification module selects a most probable set of annotations for the single piece of data which was annotated with any one of conflicting annotations and adversarial annotations.

18. The method of claim 17 further comprising:
using the unified subsequent dataset as labels for a training dataset, and using composition of those as the input for training the machine learning model;
assessing the ununified dataset with an annotation assessment module to determine at least one of: an expert competency, whether designations were applied to the annotated data in an adversarial manner, and whether a most correct designation was applied to an unannotated data sample; and
reaching an end condition wherein no further annotated data, subsequent annotated data, and unified subsequent dataset are inputted into the machine learning model.

19. A system, comprising:
a computing cluster having at least of central processors and graphics processing units each having a processor and a memory;
a network; and
an annotation server to:
determine which objects from a substantial dataset are expected to lead to the largest increase in model quality by applying a samples-selection algorithm using computational capability comprising a processor and a memory of at least one of a processing system and a graphics processing unit,
quantify an informativeness score of data elements in the substantial dataset to determine how likely and by what degree data elements will lead to model improvement,
determine which data elements of the substantial dataset are in need of human annotation based on a prioritization order derived from the informativeness score,
wherein data that would be most useful for a machine learning process based on the informativeness score is prioritized for a human review,
choose a selected data based on the automatically determining which elements of the substantial dataset are in need of human annotation based on the prioritization order derived from the informativeness score,

20. The system of claim 19 wherein the annotation server to additionally:
match the selected data to an expert based on at least one of a competency and a preference of the expert,
generate an annotation view of the selected data tailored to at least one of the preference and the competency of the expert through which the expert is able to annotate the selected data, and
adjust an estimation of competency of the expert based on based on annotations obtained from the expert, wherein the annotations match an expected unified label based on an artificial intelligence algorithm comprising at least one of a weighted voting algorithm, a multiple machine learning model algorithm, and an expectation maximization algorithm;
adjust labels corresponding to annotated elements of the selected data in response to annotations and an update to the estimation of competency of the expert;
determine that the selected data is certain enough by examining at least one of the updated competencies of the expert, consensus among multiple experts, and analysis through a machine learning model; and
re-generate the informativeness score for the substantial dataset to generate an input data for at least one of a training of the machine learning model, a retraining of the machine learning model, and a business intelligence report of an artificial intelligence application.

21. The system of claim 20 wherein the annotation server to additionally:
determine which objects from the substantial dataset are in need of repeated annotation by applying the samples-selection algorithm, which may include at least one of the following: score of annotation being trustworthy based on human annotators competence estimation on the examined sample; conformance to distribution learned by machine learning model; difficulty score based on representation of the data element;
expand a database with annotations assigned by humans to data elements in a manner that the same element may be annotated by multiple human annotators, and
apply each operation of the method to an annotation verification task to audit whether annotations of other humans are accurate.

22. The method of claim 21 wherein the annotation server to additionally:
enable other humans to perform the annotation verification task to audit annotations of other humans are accurate;
compare annotations of the human and an another human with each other; and
generate a most-probable annotation based on at least one of:
annotations assigned by human experts and their competencies,
predictions of machine learning model trained on at least one of annotations, substantial data, and historical data,
uncertainty of trained machine learning model,
annotations generated from the annotation verification task,
predictions of a machine learning model for the annotation verification task, and
uncertainty of the machine learning model for the annotation verification task.

23. The method of claim 21 wherein the annotation server to additionally:
unify the annotations of at least one of the human, the another human, and the annotation verifications with each other using a label unification module to create a unified subsequent dataset, and
wherein the label unification module selects a most probable set of annotations for the single piece of data which was annotated with any one of conflicting annotations and adversarial annotations.

24. The method of claim 23 wherein the annotation server to additionally:
utilize the unified subsequent dataset as labels for a training dataset, and using composition of those as the input for training the machine learning model.
